(19) United States
(12) Patent Application Publication
(10) Pub. No.: US 2026/0297284 A1
(43) Pub. Date: Oct. 1, 2026

(54) METHOD FOR THERMOMECHANICALLY DEVULCANISING A VULCANISED ELASTOMER

(71) Applicant: RUBBERGREEN INDUSTRIE, Frameries (BE)

(72) Inventors: Said SEGHAR, Valenciennes (FR); Olivier PRUD'HOMME, Saint Symphorien (BE)

(21) Appl. No.: 19/475,842

(22) PCT Filed: May 22, 2024
(86) PCT No.: PCT/EP2024/064016

§ 371 Date: Oct. 16, 2025

(30) Foreign Application Priority Data
May 22, 2023 (BE) BE20235418

(51) Int. Cl. C08J 11/12; B01J 8/10

(52) U.S. Cl. CPC C08J 11/12; B01J 8/10; C08J 2317/00

(57) ABSTRACT

A method for thermomechanically devulcanizing an elastomer, comprising the steps of: providing a vulcanized elastomer in the form of particles; supplying said particles upstream of an extruder which comprises at least one twin-screw having at least one reverse-pitch screw element, and which extruder is configured to move the particles within it; thermomechanically treating said particles; and supplying said devulcanized material to an outlet in order to recover a devulcanized material.

This invention relates to a method for thermomechanically devulcanising a vulcanised elastomer and also to an extruder for thermomechanically devulcanising a vulcanised elastomer.

Vulcanisation is a method that bonds the macromolecules of an elastomer together by adding a vulcanising agent, such as sulphur, to lend the treated material elastic properties. This prevents permanent deformation due to viscous flow. Typically, natural rubber is vulcanised by heating the rubber to a certain temperature, after mastication and the addition of sulphur, plasticisers, zinc oxide, and accelerators.

At the end of their life, these vulcanised products, such as lorry and aircraft tyres, are stored without any actual recovery. The storage of these used materials is becoming increasingly complicated to manage and generates relatively high costs.

Recycling these used materials by converting them into new products eliminates these storage requirements and ensures sustainable circularity in the elastomer industry, particularly in the rubber sector. The challenge lies in the quality of the recycled product, which must meet certain specifications depending on the intended application. This would promote the use of recycled materials without compromising the properties of the material based on recycled material. Given the available volumes of end-of-life vulcanised elastomers, any recovery method would be welcome.

Generally, the recycling of vulcanised elastomers includes the recycling of rubber, such as used tyres, which typically occurs through devulcanisation methods. These methods break the sulphur bonds initially formed during vulcanisation, giving the treated products a new life.

Therefore, there are different types of devulcanisation. For example, devulcanisation involves the use of chemicals to alter the product to be treated and break the sulphur bonds. Furthermore, this chemical treatment can be combined with a (thermo)mechanical treatment. Devulcanisation can also be achieved by applying microwaves or by ultrasound. Finally, there are also devulcanisation methods that involve applying a thermomechanical treatment.

US 2009 082 475 discloses a method for devulcanising vulcanised rubber. The latter is mixed with chemical additives before being introduced into an extruder to perform devulcanisation.

WO 2022 044 031 discloses another method for devulcanising vulcanised rubber, which is performed thermomechanically and without the use of chemical additives. The extruder provides a devulcanised material production throughput ranging from 2 to 10 kg/hour.

Unfortunately, current devulcanisation methods do not allow for easy, rapid, and efficient devulcanisation, particularly on an industrial scale.

There is a need to significantly reduce the use of chemicals for devulcanisation, while maintaining effective devulcanisation that meets current environmental needs, using an economically viable method. Furthermore, it would be advantageous to be able to apply a devulcanisation method without modifying the basic formula of the treated rubber (or at least only minimally).

This invention aims to provide a simple and efficient method for devulcanising a thermomechanically vulcanised elastomer that is energy-efficient and easy to implement.

To solve this problem, the invention provides a method for thermomechanically devulcanising a vulcanised elastomer, comprising the following steps:
Providing a vulcanised elastomer in the form of particles having a predetermined size distribution,
Providing an extruder which comprises at least one twin-screw mounted rotatably, preferably co-rotatably, which extends into at least three sections of said extruder, a receiving section located upstream, a devulcanisation section and an outlet section located downstream,
Bringing said particles upstream of said extruder which is arranged to move said particles within it following a rotational movement of said at least one twin-screw, downstream thereof, towards the outlet section,
Optionally, crushing said particles in a crushing section so as to reduce the particle size,
Thermomechanical treatment of said particles in the devulcanisation section to as to form a devulcanised material,
Bringing said devulcanised material to the outlet section to recover said ready-to-use devulcanised material,
   characterised in that said at least one twin-screw extending into the devulcanisation section is provided with at least one reverse-pitch screw element that is arranged to allow the movement of the particles in the opposite direction, relative to the direction of movement of said particles brought upstream of said extruder, and to hold them for a sufficient period of time to allow devulcanisation and in that these particles brought in the opposite direction are thermomechanically treated after they have been in contact with said reverse-pitch screw element.

The method according to the invention makes it possible to devulcanise a vulcanised material, which is supplied in the form of particles (granules, powder, shavings, etc.) in an extruder that comprises at least one twin-screw mounted rotatably, preferably co-rotatably or counter-rotatably.

The devulcanisation method according to the invention breaks at least the carbon-sulphur (C—S) and sulphur-sulphur (S—S) bonds of the treated particles.

The extruder has three sections: a receiving section located upstream ready to receive the particles to be treated, a devulcanisation section for thermomechanically treating these particles, and an outlet section located downstream to ensure the exit of the particles previously treated in the devulcanisation section. Said at least one twin-screw extends through said at least three sections, preferably from said receiving section to said outlet section.

Advantageously, said devulcanisation section is located between said receiving section and said outlet section.

When the particles are brought into the receiving section, they are moved by the rotation (for example, by means of a motor) of said at least one twin-screw towards the devulcanisation section.

Said at least one twin-screw extending into the devulcanisation section comprises at least one screw element with a reverse pitch, relative to the direction of movement of said particles within said extruder which are provided upstream thereof. Indeed, the particles are moved from the receiving section to the outlet section following the rotation of said at least one twin-screw. Thus, when the particles reach the devulcanisation section, they are thermomechanically treated after having been in contact with said reverse-pitch screw element.

More specifically, said at least one reverse-pitch screw element located in the devulcanisation section slightly pushes the particles upstream (backwards relative to the direction of movement), which generates a certain pressure at said at least one reverse-pitch screw element and makes it possible to hold these particles in the devulcanisation section. This is where devulcanisation takes place effectively, breaking the C—S and/or S—S bonds of the treated particles, preferably without the addition of chemical devulcanising agents. The temperature applied in the devulcanisation section can thus be greater than 250° C., preferably greater than 300° C., and even more preferably greater than 320° C.

In operation (when the particles are continuously fed into the extruder), the particles fed into the extruder will exert pressure on the devulcanised material that has been pushed backwards (relative to the direction of movement, i.e., from the receiving section to the outlet section) by said at least one reverse-pitch screw element, which leads to the devulcanised material passing towards the outlet section. A sort of looping movement is then established at this point (at the reverse-pitch screw element) in that the particles to be treated are first pushed backwards and after devulcanisation, the material is moved towards the outlet section.

Thus, the method according to the invention allows the particles to move in the opposite direction and remain in the devulcanisation section for a sufficient period of time to complete devulcanisation, preferably between 0.1 and 10 seconds, more preferably between 1 and 6 seconds.

The duration of devulcanisation may be between 1 and 4 seconds.

In a preferred embodiment, said particles are heated in the receiving or devulcanisation section. The temperature is adjusted to reach a sufficient temperature to allow devulcanisation.

It may be advantageous to perform devulcanisation in one section of said extruder in a manner that is easy and efficient for the user by applying the desired temperature in the devulcanisation section or by preparing the particles in the receiving section to improve control of the temperature in the devulcanisation section (i.e., without subsequently increasing the temperature).

Preferably, the temperature applied in the devulcanisation section may thus be greater than 210° C., preferably greater than 250° C., and more preferably greater than 320° C.

Advantageously, said sufficient temperature applied at the level of the reverse-pitch screw element may be the highest temperature applied relative to the temperatures prevailing in the other sections of said extruder. This has the advantage of aiming at an adequate devulcanisation temperature to properly treat the particles, while allowing efficient temperature management during extrusion.

Alternatively, it is also possible to apply a temperature in the receiving section that is higher than the temperatures applied in the other sections of the extruder. This can make it possible to bring the particles to a temperature suitable for devulcanisation. Thus, when they reach the devulcanisation section, the temperature is such that it is not necessary to further heat the particles, which are ready to be devulcanised. The receiving section can thus serve as a preheating step before performing devulcanisation in the corresponding section.

According to an advantageous embodiment, the crushing section corresponds to the receiving section in which any particle crushing is performed. Advantageously, the receiving section includes the crushing section, which constitutes a part thereof.

Even more advantageously, the devulcanised material is produced using the extruder at a throughput of up to 500 kg/h, preferably up to 350 kg/h, more preferably up to 300 kg/h, more preferably up to 250 kg/h, even more preferably up to 200 kg/h, advantageously up to 150 kg/h. This has the advantage of performing devulcanisation quickly and efficiently to process large quantities of vulcanised elastomer.

Preferably, the devulcanised material is produced using the extruder at a throughput of at least 50 kg/h, preferably at least 100 kg/h.

The throughput expressed above depends on the size of the extruder, which is defined relative to the diameter of the barrel in which said at least one twin-screw is housed. The barrel has a diameter between 55 and 65 mm, preferably between 60 and 65 mm. Advantageously, the barrel has a diameter of 60 mm or 65 mm. The flow throughputs given above correspond to a barrel with an (external) diameter of 65 mm.

Preferably, said at least one twin-screw located in the devulcanisation section comprises at least two screw elements: a kneading screw element designed to perform devulcanisation, followed by a reverse-pitch screw element designed to hold the particles and allow movement in the opposite direction.

Thus, the method according to the invention can advantageously be characterised in that said at least one twin-screw extending into the devulcanisation section is provided with at least one kneading screw element followed by the reverse-pitch screw element which is arranged to allow the movement of the particles in the opposite direction, relative to the direction of movement of said particles brought upstream of said extruder, and to hold them for a sufficient period of time to allow devulcanisation and in that these particles brought in the opposite direction are thermomechanically treated by said kneading screw element, after they have been in contact with said reverse-pitch screw element.

Surprisingly, the combination between this kneading screw element and this reverse-pitch screw element which constitutes the last screw element of the devulcanisation section allows devulcanisation to be performed efficiently without requiring a high heat input. Thus, the reverse-pitch screw element located in the devulcanisation section slightly pushes the particles upstream (backwards relative to the direction of movement, which generates a certain pressure at said at least one reverse-pitch screw element and allows said particles to be held in place. Then, the kneading screw element will effectively perform devulcanisation by breaking the C—S and/or S—S bonds of the treated particles, preferably without the addition of chemical devulcanisation agents. Thanks to the combination of the masticating screw element and the reverse-pitch screw element, the temperature applied in the devulcanisation section may advantageously be 220° C., preferably a maximum of 210° C. This is particularly advantageous for the user, who will be able to control the temperature within the extruder more easily, reducing the risk of material damage.

During operation (when particles are continuously fed into the extruder), the particles fed into the extruder exert pressure on the devulcanised material, causing the devulcanised material to pass toward the outlet section. A sort of looping motion is then established at this point (at the reverse-pitch screw element and the kneading screw element), in that the particles to be treated are first pushed backwards and held, then moved towards the outlet section. Thus, the reverse-pitch screw element holds the particles during the devulcanisation method, which is performed by the kneading screw element.

Advantageously, the reverse-pitch screw element constitutes the last screw element in the devulcanisation section.

Even more preferably, said at least one twin-screw located in the devulcanisation section has at least one kneading screw followed by the reverse-pitch screw element, which constitutes the last screw element in the devulcanisation section, before passing into the outlet section.

In an even more advantageous embodiment, said at least one twin-screw of the extruder has a rotation speed of between 50 and 600 rpm (rotations per minute), preferably between 250 and 450 rpm, and preferably between 300 and 400 rpm. This has the advantage of performing devulcanisation quickly and efficiently.

These rotation speeds depend on the quantity of material being treated (e.g., 60 rpm for 10 kg/h, 120 rpm to treat up to 80 kg/h, 200 rpm to treat up to 150 kg/h, 250 rpm to treat up to 200 kg/h, 300 rpm to treat up to 250 kg/h, . . . ).

According to an exemplary embodiment of the invention, said particles move in the opposite direction due to the effect of the reverse-pitch screw element and are thus held in the devulcanisation section for a period of between 0.1 and 10 seconds, preferably between 1 and 6 seconds. This has the advantage of allowing rapid and efficient devulcanisation.

According to a preferred example, said particles present in the devulcanisation section have a residence time of between 1 and 4 seconds. This has the advantage of performing devulcanisation quickly and efficiently.

Advantageously, the receiving and devulcanisation sections are heated to allow conditioning of the particles before devulcanisation.

Preferably, said devulcanisation section corresponds to at least one module having a length equal to approximately four times the diameter of said extruder.

In an advantageous embodiment, the devulcanised material is cooled in said outlet section, preferably to a temperature between 20 and 100° C. This has the advantage of obtaining a stabilised devulcanised material having a viscosity between 20 and 120 Mooney, preferably between 40 and 70 Mooney, measured according to ISO-289 or ASTM D1646-19a.

According to a preferred embodiment, the temperature applied within said devulcanisation section is between 180 and 250° C. This has the advantage of performing devulcanisation efficiently without degrading the C—C bonds within the particles. Also, the temperature applied depends on the type of elastomer particles being treated.

According to an advantageous embodiment, said devulcanisation section has a length between 4 and 8 times the diameter of the extruder, preferably between 4 and 6 times the diameter of the extruder, more preferably equal to 4 times the diameter of the extruder. This has the advantage of performing devulcanisation in a clearly defined section of the extruder.

In a preferred embodiment, the method according to the invention has an energy consumption of less than or equal to 0.5 kWh/kg, preferably less than or equal to 0.4 kWh/kg

Preferably, the method according to the invention is performed continuously.

Thus, and advantageously, the step of bringing said particles upstream of said extruder is performed continuously.

Other advantages and embodiments of the invention are discussed in the claims.

This invention also relates to an extruder for thermomechanically devulcanising a vulcanised elastomer, comprising at least one twin-screw mounted rotatably, preferably co-rotatably, which extends in at least 3 sections, a receiving section located upstream, a devulcanisation section and an outlet section located downstream, said extruder being arranged to move the vulcanised elastomer in the form of particles within it following a rotational movement of said at least one twin-screw downstream thereof, in the direction of the outlet section, characterised in that said at least one twin-screw which extends in the devulcanisation section is provided with at least one reverse-pitch screw element which is arranged to allow the movement of the particles in the opposite direction, relative to the direction of movement of said particles brought upstream of said extruder, and holding them for a sufficient period of time to allow devulcanisation and in that these particles brought in the opposite direction are thermomechanically treated after they have been in contact with said reverse-pitch screw element.

In a preferred embodiment, said particles are heated in the receiving or devulcanisation section. The temperature is adjusted to reach a sufficient temperature to allow devulcanisation.

It may be advantageous to perform devulcanisation in one section of said extruder in a manner that is easy and efficient for the user by applying the desired temperature in the devulcanisation section or by preparing the particles in the receiving section to improve control of the temperature in the devulcanisation section (i.e., without subsequently increasing the temperature).

Preferably, the temperature applied in the devulcanisation section may thus be greater than 210° C., preferably greater than 250° C., and more preferably greater than 320° C.

Advantageously, said sufficient temperature applied at the level of the reverse-pitch screw element may be the highest temperature applied relative to the temperatures prevailing in the other sections of said extruder. This has the advantage of aiming at an adequate devulcanisation temperature to properly treat the particles, while allowing efficient temperature management during extrusion.

Alternatively, it is also possible to apply a temperature in the receiving section that is higher than the temperatures applied in the other sections of the extruder. This can make it possible to bring the particles to a temperature suitable for devulcanisation. Thus, when they reach the devulcanisation section, the temperature is such that it is not necessary to further heat the particles, which are ready to be devulcanised. The receiving section can thus serve as a preheating step before performing devulcanisation in the corresponding section.

In one embodiment of the invention, the devulcanisation section may have a maximum temperature when the particles come into contact with said reverse-pitch screw element This has the advantage of performing devulcanisation in one section of said extruder in an easy and efficient manner for the user.

In one embodiment, this maximum temperature at the reverse-pitch screw element is also the highest temperature applied in the devulcanisation section and also relative to the temperatures prevailing in the other sections of said extruder. This has the advantage of targeting an appropriate devulcanisation temperature for the particles to be treated, while allowing efficient management of the devulcanisation during extrusion.

In a preferred embodiment, the extruder delivers devulcanised material at a throughput of up to 500 kg/h, preferably up to 350 kg/h, more preferably up to 300 kg/h, more preferably up to 250 kg/h, even more preferably up to 200 kg/h, advantageously up to 150 kg/h. This has the advantage of performing devulcanisation quickly and efficiently to process large quantities of vulcanised elastomer.

According to an advantageous embodiment, the receiving section may include a particle crushing section.

Advantageously, the extruder delivers devulcanised material at a throughput of at least 50 kg/h, preferably at least 100 kg/h.

The throughput expressed in the context of this invention depends on the size of the extruder, which is defined relative to the diameter of the barrel in which said at least one twin-screw is housed. The barrel has a diameter between 55 and 65 mm, preferably between 60 and 65 mm. Advantageously, the barrel has a diameter of 60 mm or 65 mm. The flow throughputs given above correspond to a barrel with an (external) diameter of 65 mm.

In an even more advantageous embodiment, said at least one twin-screw which is located in the devulcanisation section comprises at least 2 screw elements, a kneading screw element followed by a reverse pitch screw element arranged to perform devulcanisation. This has the advantage of preparing the particles for devulcanisation by kneading and then enabling devulcanisation using the reverse-pitch screw element.

Preferably, the reverse-pitch screw element constitutes the last screw element in the devulcanisation section.

Even more preferably, said at least one twin-screw located in the devulcanisation section has a series of kneading screws followed by the reverse-pitch screw element, which constitutes the last screw element in the devulcanisation section, before passing into the outlet section

In an even more advantageous embodiment, said at least one twin-screw of the extruder has a rotation speed (expressed in rotations per minute) of between 50 and 600 rpm, preferably between 250 and 450 rpm, and preferably between 300 and 400 rpm. This has the advantage of performing devulcanisation quickly and efficiently.

These rotation speeds depend on the quantity of material being treated (e.g., 60 rpm for 10 kg/h, 120 rpm to treat up to 80 kg/h, 200 rpm to treat up to 150 kg/h, 250 rpm to treat up to 200 kg/h, 300 rpm to treat up to 250 kg/h, . . . ).

According to an exemplary embodiment of the invention, said particles move in the opposite direction due to the effect of the reverse-pitch screw element and are thus held in the devulcanisation section for a period of between 0.1 and 10 seconds, preferably between 1 and 6 seconds. This has the advantage of allowing rapid and efficient devulcanisation.

According to a preferred example, said particles present in the devulcanisation section have a residence time of between 1 and 4 seconds. This has the advantage of performing devulcanisation quickly and efficiently.

Advantageously, the receiving and devulcanisation sections are heated to allow conditioning of the particles before devulcanisation.

Preferably, said devulcanisation section corresponds to at least one module having a length equal to approximately four times the diameter of said extruder.

Preferably, the outlet section has a temperature of between 20 and 100° C. This eliminates the need to place a cooling bath outside the extruder. Thus, the devulcanised material is easily extracted from the extruder.

In one embodiment, the temperature within said devulcanisation section is between 180 and 250° C. This has the advantage of performing devulcanisation efficiently without degrading the C—C bonds within the particles.

Advantageously, said devulcanisation section has a length of between 4 and 8 times the diameter of the extruder, preferably between 4 and 6, more preferably equal to 4. This has the advantage of performing devulcanisation in a clearly defined section of the extruder.

Preferably, said at least one reverse-pitch screw element constitutes the last screw element of the devulcanisation section, which is preceded by a kneading screw element designed to devulcanise the particles brought in the opposite direction and held by said at least one reverse-pitch screw element in order to perform devulcanisation.

According to one embodiment, the devulcanisation section has a temperature of between 120 and 250° C., preferably between 120 and 220° C. According to an advantageous embodiment, devulcanisation takes place at a temperature not exceeding 210° C., in particular when the kneading screw element precedes the reverse-pitch screw element present in the devulcanisation section.

In a preferred embodiment, the method according to the invention has an energy consumption of less than or equal to 0.5 kWh/kg, preferably less than or equal to 0.4 kWh/kg

The method according to this invention is advantageously performed in the absence of chemical agents.

In the context of this invention, the expression “free of chemical agents” means substantially free, particularly in an amount of less than 1% by weight, preferably less than 0.5% by weight relative to the total weight of elastomers to be treated.

The expression “diameter of the extruder” must be understood, within the context of this invention, as corresponding to the (external) diameter of a barrel in which said at least one twin-screw is housed. The barrel may have a diameter of between 55 and 65 mm, preferably between 60 and 65 mm. Advantageously, the barrel has a diameter of 60 mm or 65 mm.

The term “ready-to-use devulcanised material” means that the material provided at the end of the method can be compounded with other compounds to enable vulcanisation, the parameters of which will depend on the intended application.

Said vulcanised elastomer is advantageously derived from vulcanised elastomer waste selected from the group consisting of ethylene-propylene-diene monomer (EPDM), styrene-butadiene (SBR), natural rubber (NR), synthetic isoprene (IR), and mixtures thereof, preferably in the form of chips, granules, or powders.

The particles according to this invention can thus be selected from the group comprising chips, granules, powder, and mixtures thereof.

Said particles have a predetermined size distribution depending on the type of elastomer to be devulcanised, preferably less than 8 mm, more preferably less than 5 mm. The size distribution is an average size distribution.

Furthermore, those skilled in the art are familiar with GTR (Crushed Tyre Rubber) tyres, which comprise an elastomer selected from the group consisting of SBR, NR, SBR, and mixtures thereof. This may constitute the starting material, or the vulcanised elastomer supplied in particle form.

The extruder according to the invention primarily comprises at least one twin-screw mounted rotatably, preferably on an axis powered by a motor, and comprises at least three sections: an inlet section, a devulcanisation section, and an outlet section. Said at least one twin-screw is composed of a series of screw elements that can have different profiles, depending on the function to be used, such as conveying, kneading, shearing, crushing, etc.

Also, said at least one twin-screw extends into said at least three sections of said extruder (from the inlet section to the devulcanisation section and finally into the outlet section).

Preferably, each section of said extruder comprises a twin-screw. Thus, the extruder may comprise three twin-screws assembled together.

The extruder according to the invention may comprise a barrel in which said at least one twin-screw is housed. The barrel then extends from said inlet section to said outlet section via the devulcanisation section.

The barrel according to the invention may be heated or cooled at each section independently to ensure a controlled temperature profile along the entire length of said at least one twin-screw.

Advantageously, each section of the extruder of the invention defines at least one module that corresponds to a cylindrical sheath through which said at least one twin-screw is located.

The ratio (L/D) corresponds to the length of the screw (L) and the diameter (D) of the extruder.

According to the invention, when the extruder comprises a twin-screw extending over said 3 sections, said twin-screw has an L/D ratio of between 16 and 256, preferably between 32 and 128, more preferably between 32 and 70, advantageously between 62 and 69, more advantageously equal to 64 or 68.

Furthermore, the inlet section corresponds to at least one module which has a length of between 10 and 40 times the diameter of the extruder, preferably between 10 and 30 times the diameter of the extruder, more preferably between 20 and 28 times the diameter of the extruder.

Preferably, the outlet section corresponds to a module having a length between 10 and 50 times the diameter of the extruder, preferably between 10 and 40 times the diameter of the extruder, more preferably between 20 and 38 times the diameter of the extruder.

Advantageously, the receiving section comprises a crushing section which corresponds to at least one module having a length between 1 and 10 times the diameter of the extruder, preferably between 4 and 10 times the diameter of the extruder, more preferably still between 5 and 9 times the diameter of the extruder.

Said devulcanisation section comprises at least two screw elements having different profiles.

The last screw element of said devulcanisation section is a screw element with a reverse-pitch.

Preferably, the extruder according to this invention operates in a steady state.

In the context of this invention, a steady-state operation means that the extruder is operated so that the amount of material entering corresponds to the amount of material leaving the extruder. Therefore, there may be accelerations and decelerations of the particles/materials, but the overall balance corresponds to a steady-state operation, known to those skilled in the art.

This invention relates to a method for thermomechanically devulcanising a vulcanised elastomer.

The vulcanised elastomer is advantageously an elastomer derived from an end-of-life product such as tyres or various rubber materials. These materials are treated to provide the particles according to the invention. The use of an elastomer derived from an end-of-life product allows the method to form part of a recycling and circular economy approach, while lending the newly formed product the desired mechanical properties depending on the intended application.

The particles are fed into the receiving section of the extruder according to the invention. The extruder comprises at least one twin-screw mounted rotatably, preferably co-rotatably, which extends across at least three sections of the extruder. Indeed, the extruder comprises at least said receiving section, the devulcanisation section, and the outlet section. Thus, the twin-screw extends across all of said sections.

Preferably, the extruder is equipped with at least one sleeve that accommodates said at least one twin-screw. Said at least one twin-screw is formed from a series of screw elements that have profiles depending on the function to be performed and the section in which they are located.

Thus, the receiving section will preferably include kneading and/or conveying screw elements to move the particles to the devulcanisation section. Preferably, within the receiving section, the particles can be heated to a temperature of approximately 140° C.

The devulcanisation section contains screw elements that advantageously allow kneading and, at one of its ends (towards the outlet section), thermomechanical devulcanisation, which allows the particles to be devulcanised using the reverse-pitch screw element. More advantageously, the devulcanisation section comprises a kneading screw element followed by a reverse-pitch screw element (the last screw element in the devulcanisation section).

Before accessing the devulcanisation section, the receiving section may allow the supplied particles to be crushed to further improve/facilitate the devulcanisation step. In this case, the receiving section can then comprise crushing screw elements.

To achieve this, it is possible to have a succession of kneading screw elements to then reach at least one (preferably one) reverse-pitch screw element as described in the context of the invention. Advantageously, this screw element constitutes the last screw element present in the devulcanisation section.

As explained, this is where the particles will be moved in a loop-like motion. More specifically, the particles, optionally previously conveyed and/or kneaded, will reach the reverse-pitch screw element, where the pressure is such that the particles will be pushed backwards and held in place to enable thermomechanical devulcanisation, preferably performed with at least one kneading screw element. Thus, the newly supplied particles (particles to be treated) in the receiving section will push the devulcanised material towards the outlet section. This can be illustrated by a movement loop of the devulcanised material, pushed by the particles to be treated, towards the outlet section. This thermomechanical treatment breaks the C—S and S—S bonds of the particles (optionally crushed) to obtain the devulcanised material. The particles are preferably brought continuously upstream of the extruder.

The counter-movement of the particles increases the particle residence time within the extruder.

The particles have a residence time of between 1 and 4 seconds in the devulcanisation section, starting from the moment they are pushed back by the at least one reverse-pitch screw element and held in the devulcanisation section for the aforementioned residence time. When the residence time has elapsed, the devulcanised material is pushed towards the outlet section.

In this way, the devulcanised material reaches the outlet section where the temperature is such that it can be received outside the extruder as a ready-to-use devulcanised material.

Alternatively, it is also possible to provide devulcanised material at the extruder outlet that has a high temperature that requires cooling outside the extruder. Those skilled in the art know that a cooling bath can be provided at the extruder outlet to provide ready-to-use devulcanised material.

Thus, the outlet section preferably comprises a series of conveyor screw elements.

Preferably, the outlet section can allow cooling of the devulcanised material.

According to a preferred embodiment, the various sections of the extruder can be equipped with a cooling system throughout the entire section to manage the temperature according to the type of elastomer to be treated.

Each section can also correspond to a module in which these screw elements are present.

Within the outlet section, the devulcanised material is cooled to a temperature of approximately 50° C.

The screw elements comprising the outlet section have a screw profile that allows devulcanised material to be kneaded and moved in order to adjust the viscosity of the devulcanised material at the extruder outlet.

The extruder outlet throughput is 300 kg/hour.

### EXAMPLE 1

The devulcanisation method according to the invention was implemented with a vulcanised elastomer of the natural rubber type. The particle size distribution is between 0.5 and 5 mm.

The method was implemented using a co-rotating twin-screw extruder with an L/D ratio of 68. It includes a receiving section with a length equal to 24 times the extruder diameter, including a crushing section with a length equal to 8 times the extruder diameter, a devulcanisation section with a length equal to 8 times the extruder diameter, and an outlet section with a length equal to 36 times the extruder diameter.

The rotation speed was 120 rpm (rotations per minute).

The particles were introduced into the receiving section, which was at a temperature of 140° C.

The particles were then crushed within the crushing section at a temperature of 140° C., which is located in the receiving section.

The particles were then subjected to shearing in the devulcanisation section at a temperature of 210° C.

The devulcanised material is then cooled and stabilised in the outlet section at a temperature of 80° C.

Devulcanisation is confirmed by measuring the Mooney viscosity, which indicates a value of 50 MU. The devulcanisation throughput indicates a value of 78% with a soluble fraction of 35%

It is understood that this invention is in no way limited to the embodiments described above and that many modifications may be made thereto without departing from the scope of the appended claims.

1. Method for thermomechanically devulcanising a vulcanised elastomer, comprising the following steps:
Providing a vulcanised elastomer in the form of particles having a predetermined size distribution,
Providing an extruder which comprises at least one twin-screw mounted rotatably, preferably co-rotatably, which extends into at least three sections of said extruder, a receiving section located upstream, a devulcanisation section and an outlet section located downstream,
Bringing said particles upstream of said extruder which is arranged to move said particles within it following a rotational movement of said at least one twin-screw, downstream thereof, towards the outlet section,
Optionally, crushing said particles in a crushing section so as to reduce the particle size,
Thermomechanical treatment of said particles in the devulcanisation section to as to form a devulcanised material,
Bringing said devulcanised material to the outlet section to recover said ready-to-use devulcanised material,
characterised in that said at least one twin-screw extending into the devulcanisation section is provided with at least one reverse-pitch screw element that is arranged to allow the movement of the particles in the opposite direction, relative to the direction of movement of said particles brought upstream of said extruder, and to hold them for a sufficient period of time to allow devulcanisation and in that these particles brought in the opposite direction are thermomechanically treated after they have been in contact with said reverse-pitch screw element.

2. Method according to claim 1, wherein said particles are heated, preferably in the receiving or devulcanisation section, the temperature being adjusted so as to reach a sufficient temperature to allow devulcanisation.

3. Method according to claim 2, wherein said sufficient temperature applied at the level of the reverse-pitch screw element is optionally the highest temperature applied relative to the temperatures prevailing in the other sections of said extruder.

4. Method according to claim 1, wherein the devulcanised material is produced by means of the extruder at a rate of up to 500 kg/h, preferably up to 350 kg/h, more preferably up to 300 kg/h, even more preferably up to 250 kg/h, advantageously up to 200 kg/h, more advantageously up to 150 kg/h.

5. Method according to claim 1, wherein said at least one twin-screw located in the devulcanisation section comprises at least two screw elements, a kneading screw element arranged to perform devulcanisation followed by a reverse-pitch screw element arranged to allow the movement of the particles in the opposite direction for a sufficient period of time to perform devulcanisation.

6. Method according to claim 1, wherein said at least one twin-screw of the extruder has a rotation speed, preferably in a steady state, of between 50 and 600 rpm, preferably between 250 and 450 rpm, preferably between 300 and 400 rpm.

7. Method according to claim 1, wherein said particles move in the opposite direction due to the effect of the reverse-pitch screw element and are held in the devulcanisation section for a period of time between 0.1 and 10 seconds, preferably between 1 and 6 seconds.

8. Method according to claim 1, wherein said particles have a residence time in the devulcanisation section of between 0.1 and 4 seconds, advantageously corresponding to the duration of the devulcanisation.

9. Method according to claim 1, wherein said devulcanisation section corresponds to a module having a length equal to 4 times the diameter of the extruder.

10. Method according to claim 1, wherein cooling of the devulcanised material is performed in said outlet section, preferably to a temperature between 20 and 100° C.

11. Method according to claim 1, wherein the temperature applied within said devulcanisation section is between 180 and 250° C.

12. Method according to claim 1, wherein said devulcanisation section has a length of between 4 and 8 times the diameter of the extruder, preferably between 4 and 6, more preferably equal to 4.

13. Extruder for thermomechanically devulcanising a vulcanised elastomer, comprising at least one twin-screw mounted rotatably, preferably co-rotatably, which extends in at least 3 sections, a receiving section located upstream, a devulcanisation section and an outlet section located downstream, said extruder being arranged to move the vulcanised elastomer in the form of particles within it following a rotational movement of said at least one twin-screw downstream thereof, in the direction of the outlet section, characterised in that said at least one twin-screw which extends in the devulcanisation section is provided with at least one reverse-pitch screw element which is arranged to allow the movement of the particles in the opposite direction, relative to the direction of movement of said particles brought upstream of said extruder, and holding them for a sufficient period of time to allow devulcanisation and in that these particles brought in the opposite direction are thermomechanically treated after they have been in contact with said reverse-pitch screw element.

14. Extruder according to claim 14, wherein said at least one reverse-pitch screw element constitutes the last screw element of the devulcanisation section, which is preceded by a kneading screw element designed to devulcanise the particles fed in the opposite direction and held by said at least one reverse-pitch screw element in order to perform devulcanisation.
